(19) United States
(12) Patent Application Publication
(10) Pub. No.: US 2003/0209661 A1
(43) Pub. Date: Nov. 13, 2003

(54) Light-blocking structure on optical lens mounting device

(76) Inventors: Cheng-Kuei Chen, Hsinchu (TW); Chih-Chien Jen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,738

(22) Filed: May 9, 2002

(51) Int. Cl. H01J 5/02

(52) U.S. Cl. 250/239

(57) ABSTRACT

A light-blocking structure on an optical lens mounting device for an optical scanning module. A circular flange is formed inside an engaging tube adjacent to one end of the optical lens for blocking any diffused light passing through the gap between the optical lens and the engaging tube so that an associated optical sensor may obtain a clearer image.

### BACKGROUND OF INVENTION

1. Field of Invention

The present invention relates to a light-blocking structure associated with an optical lens mounting device. More particularly, the present invention relates to a light-blocking structure on an optical lens mounting device capable of blocking most strayed light passing through the gap between the optical lens and the optical lens mounting device.

2. Description of Related Art

Nowadays, image input, processing and modification have become such a favorite pastime that a scanner is a piece of indispensable equipment for a computer user. Text or image data from documents, journals, books and pictures may be scanned into a computer for subsequent processing. Amongst the various types of scanners, platform scanners are most widely used. In a platform scanner, the scanning module capable of shuttling forward and backward is mounted beneath a transparent platform. Since the scanning module is not self-driven, the scanning module is linked to other driving devices including a server motor, gear wheels, leather belts and so on. To scan a document, the document is put on the transparent platform. A cover panel is lowered to flatten out the document on the transparent platform before a start button is pressed to initiate the scanning operation.

FIG. 1 is a schematic diagram showing a conventional optical scanning module. As shown in FIG. 1, the optical scanning module includes a light source 100, a set of reflecting mirrors 400, an optical lens assembly 500, an optical sensor 600 (for example, a charge-coupled device (CCD)) and a body casing 700. The optical source 100, the set of reflecting mirrors 400, the optical lens assembly 500 and the optical sensor 600 are housed inside the body casing 700. During a scanning operation, the light source 100 illuminates a document 200 placed over a transparent panel 300 and produces an image after light reflection or transmission through the transparent panel 300. The set of reflecting mirrors 400 comprises a plurality of reflecting mirrors (401, 402, 403). The reflecting mirrors 400 are positioned along the optical path of the document image so that an image of the document 200 is channeled into the set of reflecting mirrors 400. After passing through the mirrors 400, the image is deflected into the optical lens 500. The optical lens 500 picks up light from the mirrors 400 and forms an image of the document 200 at the charge-coupled device 600. A mounting device is used to hold the optical lens 500 inside the body casing 700. In general, this mounting device has a cylindrical structure. In earlier systems, the optical lens 500 simply slides into the cylindrical hole of the mounting device as shown in FIG. 3a.

However, a mounting system relying on matching axial hole tolerance often leads to considerable deviation so that repeated adjustment of the optical lens 500 is always required. Hence, an additional assembly for mounting the optical lens is introduced. FIG. 2 is a schematic diagram showing an assembly for mounting an optical lens. As shown in FIG. 2, the optical lens mounting assembly 800 is installed inside the body casing 700 and manufactured as an integrative unit together with the body casing 700. The optical lens mounting assembly 800 has a trapezoidal base block having a hollow cylinder 810 up front for stationing an optical lens 500. At the bottom of the engaging tube 810, there is a spring plate 812. The spring plate 812 has a spine 814 protruding into the interior of the cylinder 810. The protruding spine 814 presses against the optical lens 500 once the lens 500 is slid into the hollow cylinder 810. Image focus may be adjusted by moving the optical lens 500 forward or backward within the confine of the cylinder 810 in the axial direction as shown in FIG. 3b. After focusing adjustment of the lens, the optical lens 500 is fixed in position by applying some glue, or locked up by tightening a screw. Hence, through the pressure exerted by the spring 812 and the tightening force of the screw as well as the point contact between the protruding spine 814 and the optical lens 500, axial position of the optical lens 500 is precisely set.

The number of protruding spines 814 may also be increased to two as shown in FIG. 3c. In addition, the engaging tube 810 may also be designed to have a triangular shape as shown in FIG. 3d so that the cylinder 810 forms a three-point contact with the optical lens 500 for more accurate determination of axial position. However, no matter which type of design, internal diameter of the engaging tube 810 is always made larger than the outer diameter of the optical lens 500 for ease of assembly. Consequently, a gap 508 (the slash-shaded areas in FIGS. 3a˜3d) always exists between the engaging tube 810 and the optical lens 500. Because of this, the optical sensor 600 may capture diffused light (or stray light) 101 (FIG. 4) aside from image light from the optical lens 500 proper leading to image deterioration. If a component is added to block out the diffused light 101 from the gap 508, additional cost and extra labor is required.

### SUMMARY OF INVENTION

Accordingly, one object of the present invention is to provide a light-blocking structure on a mounting device for holding an optical lens. The light-blocking structure is a circular flange on the inner surface of an engaging tube adjacent to one end of the optical lens capable of blocking strayed light passing through the gap between the optical lens and the engaging tube is blocked. Hence, quality of the image formed on an associated optical sensor is improved.

To achieve these and other advantages and in accordance with the purpose of the invention, as embodied and broadly described herein, the invention provides a light-blocking structure on the optical lens mounting device of an optical scanning module. The optical scanning module at least includes an optical lens and a device for mounting the optical lens. The mounting device has an engaging tube for housing the optical lens. When the optical lens is slid into the engaging tube, there is a gap between the optical lens and the engaging tube. The light-blocking structure on the mounting device includes a circular flange attached to the interior sidewall right angle to the axial direction of the cylinder and adjacent to the one end of the optical lens. The circular flange and the engaging tube may be manufactured as an integrative unit. Height of the circular flange is greater than the gap width so that any diffused light passing through the gap is blocked.

This invention also provides the scanning module of an optical scanner for scanning a document. The scanning module at least includes a body casing, a light source, a set of reflecting mirrors, a mounting device, an optical lens and an optical sensor. The light source is set up inside the body casing. The light-reflecting mirrors are also set up inside the body casing along the optical path for forming an image. The mounting device is fixed onto the body casing. The mounting device has an engaging tube with a circular flange attached to the interior sidewall right angle to the axial direction of the cylinder. The circular flange and the engaging tube may be manufactured as an integrative unit. The optical lens slides into the engaging tube with one end of the lens adjacent to the circular flange. There is a gap between the optical lens and the engaging tube. However, the gap has a width smaller than the height of the circular flange inside the engaging tube. The optical lens is located somewhere along the optical path after reflection through the set of reflecting mirrors. The optical sensor is attached to the body casing and positioned in such a way to intercept light coming from the optical lens.

In brief, one major aspect of this invention is the attachment of a circular flange inside the engaging tube to serve as a light-blocking structure for diffused light. Since the circular flange and the engaging tube are fabricated as an integrative unit, there is no need to provide a separate light-blocking component. Hence, some production cost is saved.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a side view of a conventional optical scanning module;

FIG. 2 is a perspective view showing an assembly for mounting an optical lens;

FIGS. 3a˜3d are front views showing an optical lens slid into different type of engaging tubes;

FIG. 4 is a schematic cross-sectional view of an assembly showing a conventional optical lens inside a conventional engaging tube;

FIG. 5 is a side view of an optical scanning module according to one preferred embodiment of this invention;

FIG. 6 is a perspective view showing an optical lens and an engaging tube fabricated according to this invention;

FIG. 7 is a schematic cross-sectional view of an assembly showing an optical lens inside an engaging tube fabricated according to this invention; and

FIG. 8 is a schematic cross-sectional view of an assembly showing an optical lens inside an engaging tube having an alternative design.

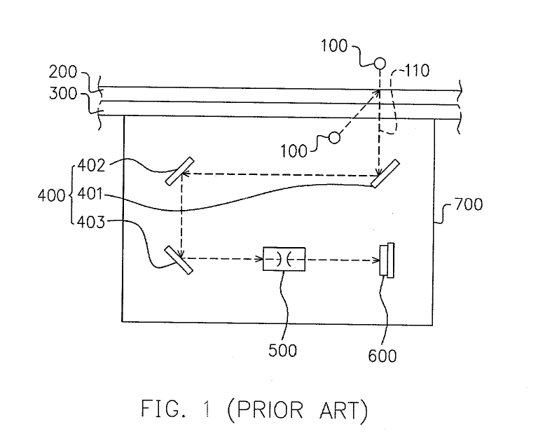

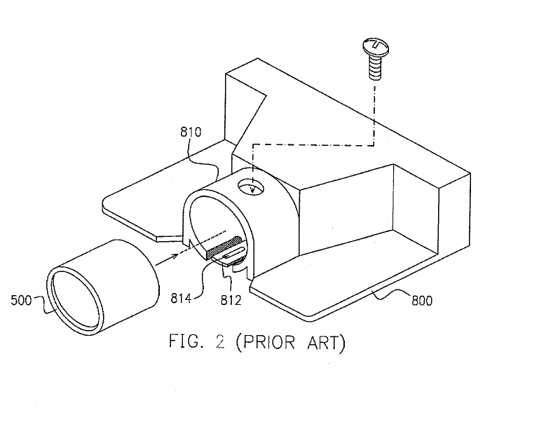

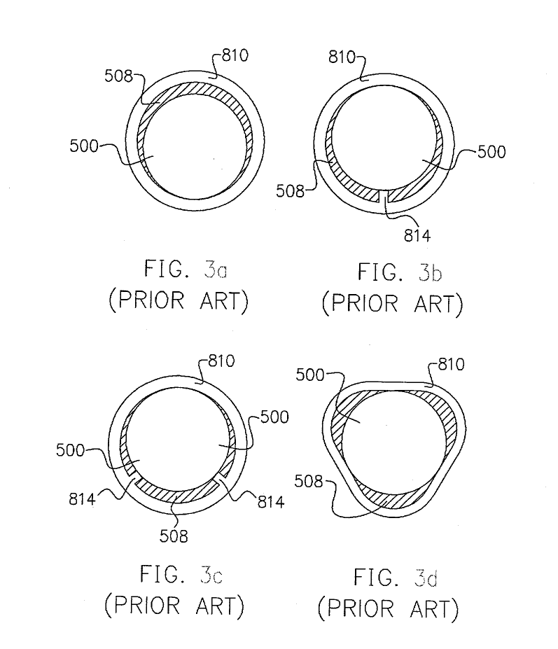

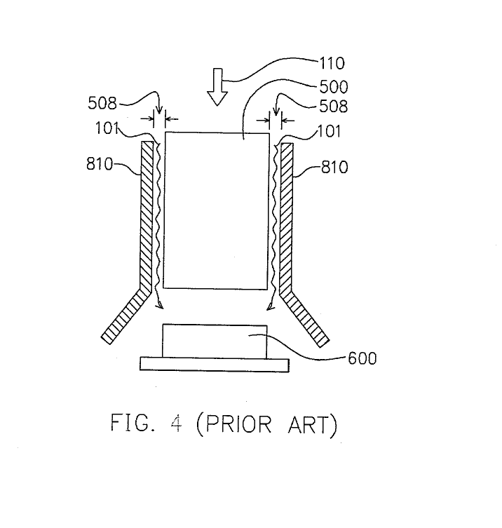

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

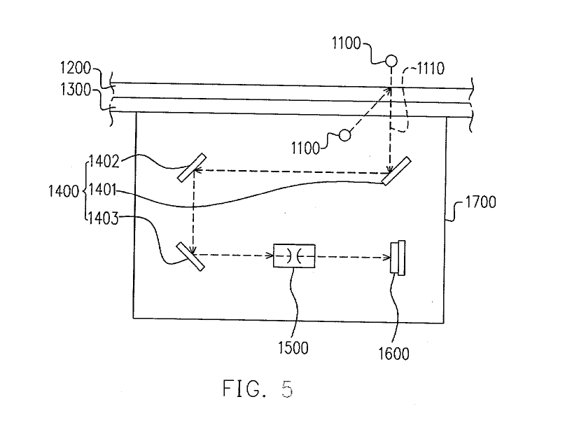

FIG. 5 is a side view of an optical scanning module according to one preferred embodiment of this invention. The optical scanning module in FIG. 5 includes a light source 1100, a set of reflecting mirrors 1400, an optical lens 1500, a body casing 1700 and an optical sensor 1600 such as a charge-coupled device (CCD). The light source 1100, the reflecting mirrors 1400, the optical lens 1500 and the optical sensor 1600 are all housed inside the body casing 1700. To conduct a scanning operation, the light source 1100 illuminates a document 1200 on a transparent panel 1300. After reflection or transmission through the transparent panel 1300, a light image 1110 of the document 1200 is produced. The set of reflecting mirrors (1401, 1402 and 1403) is positioned along the path of the light image 1110. The set of mirrors 1400 deflects the image 1110 from the document 1200 and re-directs the image 1110 into the optical lens 1500. After receiving the light image 1110 from the document 1200, the optical lens 1500 forms an image in the charge-coupled device 1600.

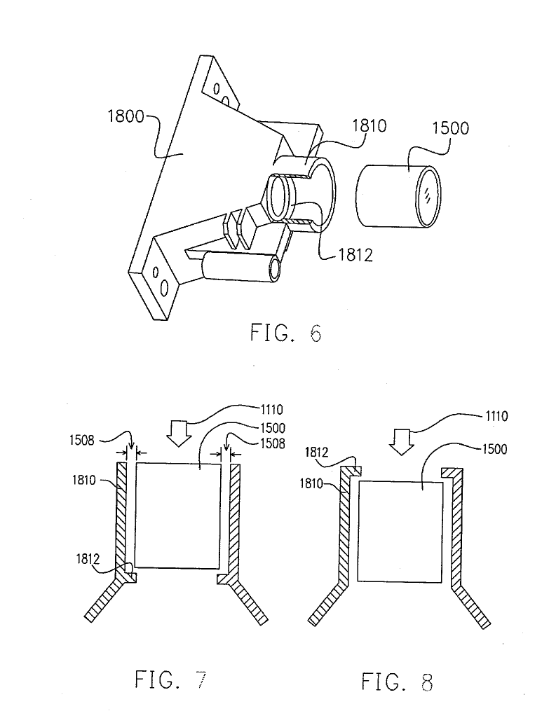

FIG. 6 is a perspective view showing an optical lens and an engaging tube fabricated according to this invention. As shown in FIG. 6, a mounting device 1800 for mounting the optical lens 1500 is installed inside the body casing 1700. The mounting device 1800 has an engaging tube 1810 for engaging and positioning the optical lens 1500. The engaging tube 1810 further includes a circular flange attached to the interior wall right angle to the axial direction of the cylinder 1810 and adjacent to the inner end of the optical lens 1500 as shown in FIG. 7. To facilitate the observation of the protruding circular flange 1812, a quarter of the engaging tube 1810 is cut open with the cut surface shaded. The circular flange 1812 has a height greater than width of the gap 1508 between the optical lines 1500 and the engaging tube 1810 so that the circular flange 1812 serves as a mask for blocking off any diffused light that happens to pass through the gap 1508. Due to the presence of raised circular flange 1812 inside the engaging tube 1810, the diameter of the cylinder 1810 is slightly smaller than the diameter of the optical lens 1500. However, such reduction in the diameter is unlikely to block the transmission of a light image 1110 through the optical lens 1500. Furthermore, the circular flange 1812 and the engaging tube/mounting device 1800 may be fabricated together as a single unit. Similarly, the mounting device 1800 and the body casing 1700 may also be fabricated together as an integrative unit.

FIG. 8 is a schematic cross-sectional view of an assembly showing an optical lens inside an engaging tube having an alternative design. The circular flange 1812 may also attach to the interior sidewalls of the engaging tube 1810 but adjacent to the outer end of the optical lens 1500. With this arrangement, the circular flange 1812 is similarly capable of blocking off any diffused light passing through the gap 1508.

In conclusion, the formation the engaging tube together with a circular flange attached to the interior sidewall of the engaging tube as an integrative unit eliminates the need to install a separate light-blocking component. In fact, the optical lens of any imaging device may employ the light-blocking structure of this invention as long as there is a gap between the optical lens and its cylindrical outer casing.

Accordingly, one major advantage of this invention is the integration of a circular flange for blocking strayed light within the engaging tube so that the need to produce a separate light-blocking component is eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A light-blocking structure on an optical lens mounting device for an optical scanning module, wherein the optical scanning module at least includes an optical lens and an optical lens mounting device, the optical lens mounting device has an engaging tube therein for stationing the optical lens, and there exists a gap between the optical lens and the engaging tube, the light-blocking structure of the optical lens mounting device comprising:
a circular flange attached to the interior sidewall of the engaging tube right angle to the axial direction of the engaging tube adjacent to one end of the optical lens, wherein the circular flange has a height greater than width of the gap.

2. The light-blocking structure of claim 1, wherein the circular flange and the engaging tube are formed together as an integrative unit.

3. An optical scanning module inside an optical scanner for scanning a document, the optical scanning module comprising:
a body casing;
a light source mounted to the body casing for illuminating the document and producing a light image;
a set of reflecting mirrors mounted to the body casing positioned somewhere along the optical path of the light image;
an optical lens mounting device mounted to the body casing, wherein the mounting device has an engaging tube with a circular flange therein such that the circular flange is attached to the interior sidewall of the engaging tube right angle to the axial direction of the cylinder;
an optical lens inside the engaging tube such that one end of the optical lens is adjacent to the circular flange and a gap exists between the optical lens and the engaging tube, wherein the gap is smaller than the height of the circular flange and the optical lens is positioned somewhere along the optical path of the light image after emerging from the set of reflecting mirrors; and
an optical sensor mounted to the body casing and positioned somewhere along the optical path of the image light after emerging from the optical lens.

4. The optical scanning module of claim 3, wherein the optical lens mounting device and the body casing are fabricated together to form an integrative unit.

5. The optical scanning module of claim 3, wherein the circular flange and the engaging tube are fabricated together to form an integrative unit.
